(19) United States
(12) Patent Application Publication
(10) Pub. No.: US 2009/0313987 A1
(43) Pub. Date: Dec. 24, 2009

(54) Driving Assistance System for Power Steering Wheel

(76) Inventor: Yu-Ta Tu, Taipei City (TW)

Correspondence Address: David Shung, P.O. Box 10557, Taipei, 100, TW

(21) Appl. No.: 12/485,133

(22) Filed: Jun. 16, 2009

(30) Foreign Application Priority Data
Jun. 20, 2008 (TW) 097122963

(51) Int. Cl. F16D 31/02

(52) U.S. Cl. 60/429

(57) ABSTRACT

The driving assistance system for power steering wheel provides various setting statuses of assisting power so that starting and stopping of the power assistance can be adjusted according to practical conditions. The adjustable contents can be set by manufactures, service technicians or drivers according to battery capacity, vehicle speed or both of them. The system can provide multiple control modes for power assistance to match various requirements.

### BACKGROUND OF THE INVENTION

1. Technical Field

The invention generally relates to power steering of automobiles, particularly to adjustable control of assisting power of power steering wheels.

2. Related Art

As shown in FIG. 1, in a conventional hydraulic power assisted steering system, an engine 93 drives an oil supplying pump 92 to push power steering oil into a steering mechanism 91. A power assisted function of the power steering wheel 90 can perform to make wheels 94 rotate when the engine has been ignited.

At high engine speeds the steering would naturally operate faster than at low engine speeds. Thus a force which needing to be applied at the steering wheel 90 for rotating would become too light at high engine speed. High engine speed usually means high traveling speed. It is very dangerous when a light rotating force is needed by the steering wheel 90 during high speed traveling. Undesired steering tends to occur at high traveling speed.

Steering assistance ceases when the engine 93 stops. Thus the steering wheel 90 will be very hard to rotate if the engine 93 malfunctions. Further, forcing the steering wheel 90 to rotate when no power steering oil is supplied can result in damage of the steering mechanism 91 easily.

More fuel will be consumed when the engine 93 drives the pump 92. It will be an additional drawback in a circumstance of high petroleum price.

On the other side, some engine-powered vehicles to be adapted into electric vehicles are difficult to employ power assisted steering under an existing hydraulic steering system.

### SUMMARY OF THE INVENTION

An object of the invention is to provide a driving assistance system which can switch a power source of the oil supplying pump.

To accomplish the above object, the driving assistance of the invention includes:

a pumping motor for driving the oil supplying pump;

a switch device connected between the pumping motor and a vehicle power source for switching either thereof as a power source of the oil supplying pump, wherein the switch device is connected to the oil supplying pump by a transmission element;

a switch control unit for controlling the switch device to connect the pumping motor or the vehicle power source, being an electronic component capable of receiving, sending and processing signals;

a main control unit for controlling the pumping motor to start or stop, being an electronic component capable of controlling a command to be sent;

a battery for providing electric power to the pumping motor; and

a driving device, receiving signals from the main control unit and electric power from the battery to drive the pumping motor;

wherein the switch device connects an input end of the oil supplying pump with the vehicle power source when the vehicle power source is operating; the switch device switches to connect the input end of the oil supplying pump with the pumping motor to have the oil supplying pump driven by the pumping motor when the vehicle power source stops, rotation speed of the vehicle power source lowers below a predetermined value, or reduction of consumption of the vehicle power source is required;

wherein when switching, the switch control unit sends signals to the main control unit to control the pumping motor, and the main control unit sends a command to the driving device to have the pumping motor powered by the battery.

Additionally, the invention also provides another embodiment, in which the driving assistance system is irrelative to the vehicle power source so that it is easier in implement.

The advantages of the invention include:

1. providing an effective and flexible driving assistance system;

2. being suitable for adapting an existing vehicle in a post-sale service;

3. being suitable for hybrid power vehicles and electric vehicles; and

4. being suitable for those electric vehicles which were adapted from original engine vehicles.

### BRIEF DESCRIPTION OF THE DRAWINGS

FIG. 1 shows a systematic block diagram of a conventional power steering system;

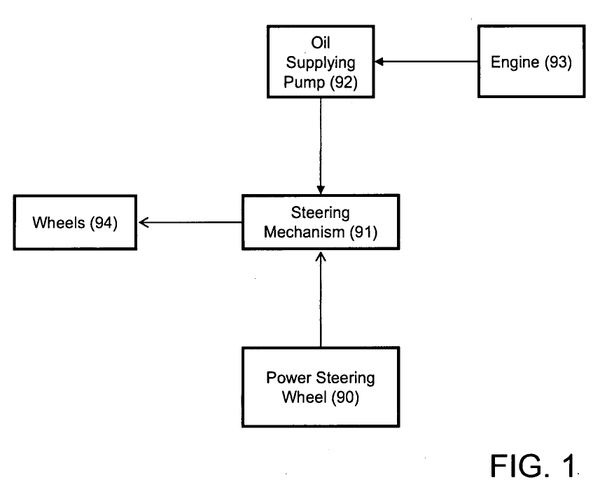

FIG. 2 shows a systematic block diagram of the power steering system of the invention;

FIG. 3 shows a systematic block diagram of the second embodiment without relationship with the vehicle power source of the invention;

FIG. 4 shows a structural diagram of the first embodiment of the invention; and

FIG. 5 shows a structural diagram of the second embodiment of the invention.

### DETAILED DESCRIPTION OF THE INVENTION

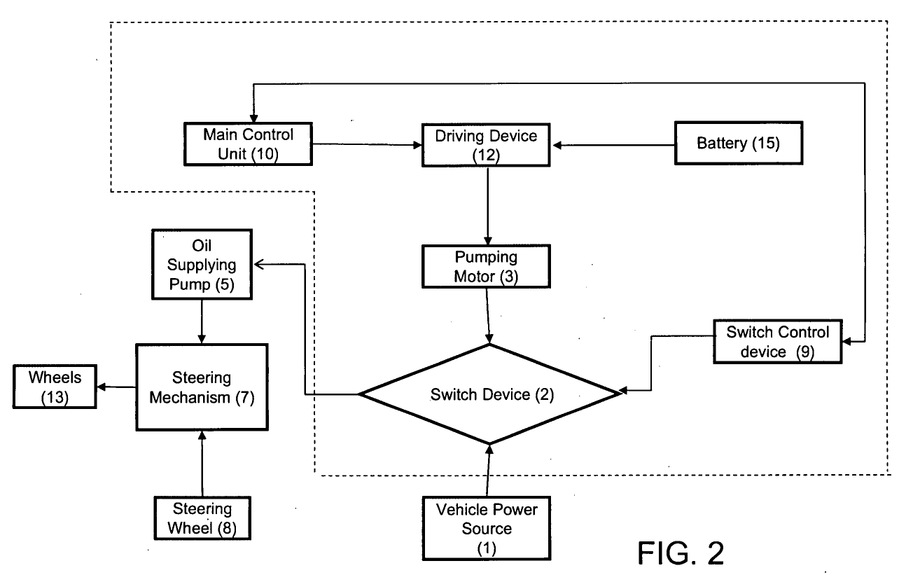

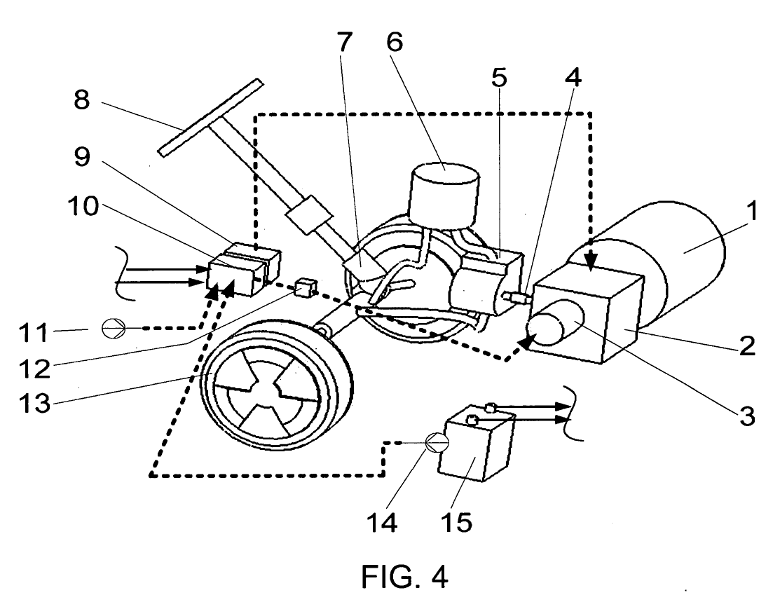

FIGS. 2 and 4 illustrate the intelligent driving assistance system for power steering of vehicles according to the present invention. The system connects to a vehicle power source 1 for making wheels 13 steer through a steering mechanism 7 operated by a steering wheel 8 and is switchable. An oil supplying pump 5 supplies hydraulic oil to the steering mechanism 7. In a normal state, the oil supplying pump 5 is controlled by the vehicle power source 1.

The driving assistance includes:

a main control unit 101 being an electronic component capable of receiving, processing and sending signals, such as a vehicle computer, a microprocessor or a single-chip computer; wherein the main control unit 10 further includes:
a vehicle speed detector 11 for receiving sensed signals; and
a battery capacity detector 14 for receiving sensed signals;

a driving device 12 primarily composed of one or more driving components, mechanic or electrical switch components or power amplifying components such as diodes, thyristors or transistors, and further including some other necessary components for matching the abovementioned components;

a battery 15 for providing electric power to other components, being a main battery of an electric power system of the vehicle, a second battery besides the main battery or any other batteries, and being a lead-acid battery, a lithium battery, a solar battery, fuel battery or any other batteries;

a pumping motor 3 for driving the oil supplying pump 5, being a DC motor or an AC motor;

a switch device 2 for switching power source of the oil supplying pump 5, being a shaft-connecting device, belt, gear or any other similar transmission elements; and

a switch control unit 9, being an electronic component capable of receiving, processing and sending signals, such as a vehicle computer, microprocessor, digital signal processor or single chip computer.

The switch control unit 9 can be an automatic manual device by a switch operation, and can be associated with the main control unit 10 to form a single control module.

The vehicle power source 1 can be an engine of a petroleum vehicle, a motor of an electric vehicle or any other power sources. The oil supplying pump 5 connects to an end of a transmission element 4. The other end of the transmission element 4 is connects to the pumping motor 3. Thus the pumping motor 3 can drive the transmission element 4 and then drive the oil supplying pump 5. The switch device 2 connects between the pumping motor 3 and the vehicle power source 1 for switching either thereof as a power source of the oil supplying pump 5. The switch device 2 switches an input end of the oil supplying pump 5 to connect t the vehicle power source 1 when the vehicle power source 1 is operating. The switch device 2 switches to connect the input end of the oil supplying pump 5 with the pumping motor 3 to have the oil supplying pump 5 driven by the pumping motor 3 when the vehicle power source stops, rotation speed of the vehicle power source 1 lowers below a predetermined value, or reduction of consumption of the vehicle power source 1 is required.

The switch device 2 can be automatically controlled by the switch control unit 9 or manually controlled by a driver. When switching, the switch control unit 9 sends signals to the main control unit 10 to control the pumping motor 3.

When the driver selects the manual control mode, the power source of the oil supplying pump 5 can be the pumping motor 3 or the vehicle power source 1 by a manual operation.

In an automatic control mode, the power source of the oil supplying pump 5 will be switched to the pumping motor 3 when a rotation speed to the oil supplying pump 5 from the vehicle power source 1 has lowered below a required rotation speed that the oil supplying pump 5 pushes hydraulic oil to the steering mechanism 7. When the oil supplying pump 5 is driven by the pumping motor 3, the main control unit 10 sends a command to the driving device 12 to have the pumping motor 3 powered by the battery 15. The oil supplying pump 5 pushes hydraulic oil from an oil tank 6 to the hydraulic steering mechanism 7 to make the driver obtain a power assistance when he or she rotate the steering wheel 8.

When the oil supplying pump 5 is driven by the pumping motor 3, the main control unit 10 receives signals from the switch control unit 9. Thus an intelligent power assistance can be performed by the main control unit 10. The control manners are described as following.

<1> First Simple Control Based on Speed

The power assistance is more required in low speed traveling, so a speed value can be an only factor to decide when to start or stop the power assistance. The speed detector II sends a speed value to the main control unit 10, and then the main control unit 10 controls the pumping motor 3 to start or stop. For example, the power assistance is started when the speed value is below 5 Km/hr and is stopped when the speed value is above 5 Km/hr.

<2> Second Simple Control Based on Battery Capacity

An additional electric power of the battery 15 will be consumed when the oil supplied pump 5 is driven by the pumping motor 3, so the battery capacity also can be an only factor to decide when to start or stop the power assistance. The battery capacity detector 14 sends a battery capacity value to the main control unit 10, and then the main control unit 10 controls the pumping motor 3 to start or stop. For example, the power assistance is started when the battery capacity value is above 20% and is stopped when the battery capacity value is below 20%.

<3> Advanced Intelligent Control Based on Both Speed and Battery Capacity

The main control unit 10 can perform a flexible control to the power assistance according to both a speed value and a battery capacity value. For example, the power assistance is started when the battery capacity value is above a first battery capacity threshold (such as 50%) and the speed value is below a first speed threshold (such as 30 Km/hr). The power assistance is started when the battery capacity value is between the first battery capacity threshold and a second battery capacity threshold (such as 30%) and the speed value is below a second speed threshold (such as 15 Km/hr). The power assistance is started when the battery capacity value is between the second battery capacity threshold and a third battery capacity threshold (such as 10%) and the speed value is below a third speed threshold (such as 5 Km/hr). Those thresholds can be set by vehicle manufactures, service centers or manufactures of steering systems.

<4> Self-Settable Advanced Intelligent Control Based on Speed, Battery Capacity and Adjustable Thresholds Set by Drivers

The main control unit 10 can also be configured to accept parameters input by drivers for allowing drivers to set starting and stopping of the power assistance according to individual circumstances, such as personal property, vehicle type, road condition, etc. Besides, the system can be provided with a memory function to store various custom sets.

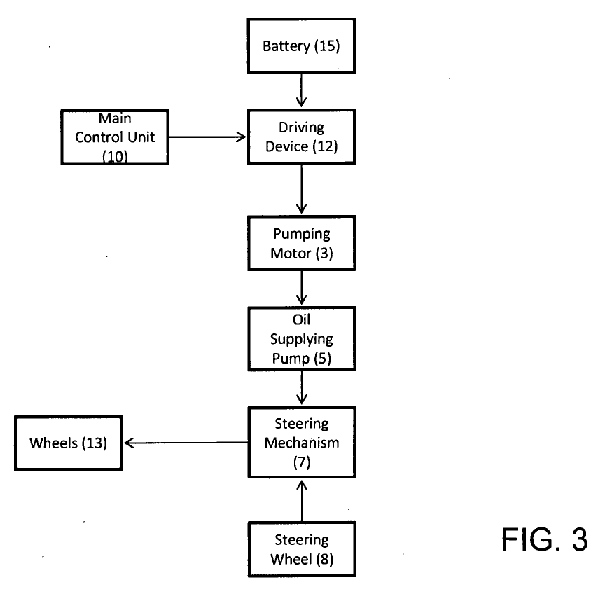

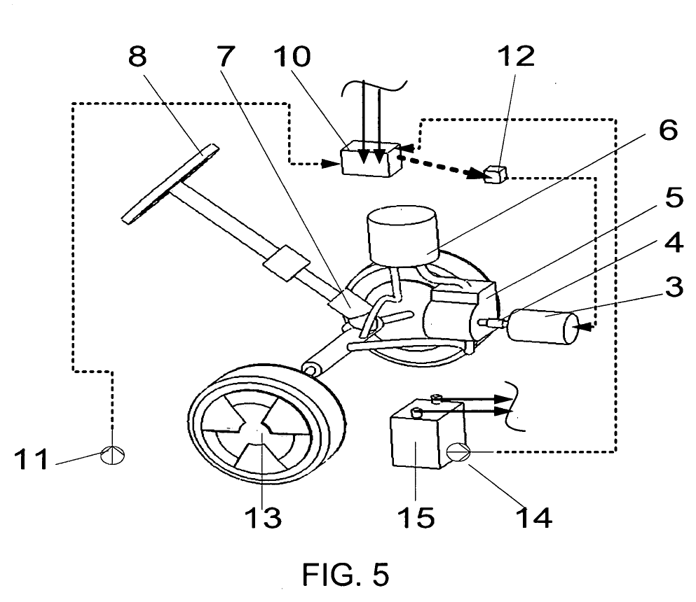

FIGS. 3 and 5 illustrate the second embodiment of the invention, in which the same elements as the above embodiment will use the same reference numbers and not be described repeatedly.

In this embodiment, the driving assistance system for power steering does not connect to the vehicle power source, i.e. an independent system. In comparison with the above embodiment, the only difference is removal of the switch device 2 and integration of the switch control unit 9 and the main control unit 10. In this embodiment, the oil supplying pump 5 is driven only by the pumping motor 3 without relationship with the vehicle power source. Thus, the oil supplying pump 5 will operate regardless of status of the vehicle power source.

After an electric power of the vehicle is activated, the main control unit 10 sends a command to the driving device 12 to have the pumping motor 3 powered by the battery 15.

The oil supplying pump 5 push hydraulic oil from an oil tank 6 to the hydraulic steering mechanism 7 to make the driver obtain a power assistance when he or she rotate the steering wheel 8.

When the electric power has been activated, the main control unit 10 performs intelligent control to the power assistance of the power steering. The control manners are described as following.

<1> First Simple Control Based on Speed

The power assistance is more required in low speed traveling, so a speed value can be an only factor to decide when to start or stop the power assistance. The speed detector 11 sends a speed value to the main control unit 10, and then the main control unit 10 controls the pumping motor 3 to start or stop. For example, the power assistance is started when the speed value is below 5 Km/hr and is stopped when the speed value is above 5 Km/hr.

<2>Second Simple Control Based on Battery Capacity

An additional electric power of the battery 15 will be consumed when the oil supplied pump 5 is driven by the pumping motor 3, so the battery capacity also can be an only factor to decide when to start or stop the power assistance. The battery capacity detector 14 sends a battery capacity value to the main control unit 10, and then the main control unit 10 controls the pumping motor 3 to start or stop. For example, the power assistance is started when the battery capacity value is above 20% and is stopped when the battery capacity value is below 20%.

<3> Advanced Intelligent Control Based on Both Speed and Battery Capacity

The main control unit 10 can perform a flexible control to the power assistance according to both a speed value and a battery capacity value. For example, the power assistance is started when the battery capacity value is above a first battery capacity threshold (such as 50%) and the speed value is below a first speed threshold (such as 30 Km/hr). The power assistance is started when the battery capacity value is between the first battery capacity threshold and a second battery capacity threshold (such as 30%) and the speed value is below a second speed threshold (such as 15 Km/hr). The power assistance is started when the battery capacity value is between the second battery capacity threshold and a third battery capacity threshold (such as 10%) and the speed value is below a third speed threshold (such as 5 Km/hr). Those thresholds can be set by vehicle manufactures, service centers or manufactures of steering systems.

<4> Self-Settable Advanced Intelligent Control Based on Speed, Battery Capacity and Adjustable Thresholds Set by Drivers

The main control unit 10 can also be configured to accept parameters input by drivers for allowing drivers to set starting and stopping of the power assistance according to individual circumstances, such as personal property, vehicle type, road condition, etc. Besides, the system can be provided with a memory function to store various custom sets.

It will be appreciated by persons skilled in the art that the above embodiments have been described by way of example only and not in any limitative sense, and that various alterations and modifications are possible without departure from the scope of the invention as defined by the appended claims.

What is claimed is:

1. A driving assistance system for power steering of a vehicle, wherein wheels of the vehicle are controlled to steer by a steering mechanism, an oil supplying pump supplies hydraulic oil to the steering mechanism, and the oil supplying pump is capable of operating in various modes, the driving assistance system comprising:
a pumping motor for driving the oil supplying pump;
a switch device connected between the pumping motor and a vehicle power source for switching either thereof as a power source of the oil supplying pump, wherein the switch device is connected to the oil supplying pump by a transmission element;
a switch control unit for controlling the switch device to connect the pumping motor or the vehicle power source, being an electronic component capable of receiving, sending and processing signals;
a main control unit for controlling the pumping motor to start or stop, being an electronic component capable of controlling a command to be sent;
a battery for providing electric power to the pumping motor; and
a driving device, receiving signals from the main control unit and electric power from the battery to drive the pumping motor;
wherein the switch device connects an input end of the oil supplying pump with the vehicle power source when the vehicle power source is operating; the switch device switches to connect the input end of the oil supplying pump with the pumping motor to have the oil supplying pump driven by the pumping motor when the vehicle power source stops, rotation speed of the vehicle power source lowers below a predetermined value, or reduction of consumption of the vehicle power source is required;
wherein when switching, the switch control unit sends signals to the main control unit to control the pumping motor, and the main control unit sends a command to the driving device to have the pumping motor powered by the battery.

2. The driving assistance system of claim 1, wherein the main control unit further comprises a vehicle speed detector, thereby when the oil supplying pump is driven by the pumping motor and an assistance control is performed by the main control unit, a power assistance for a steering wheel is started or stopped according to a speed value from the vehicle speed detector.

3. The driving assistance system of claim 1, wherein the main control unit further comprises a battery capacity detector, thereby when the oil supplying pump is driven by the pumping motor and an assistance control is performed by the main control unit, a power assistance for a steering wheel is started or stopped according to a battery capacity value from the battery capacity detector.

4. The driving assistance system of claim 1, wherein the main control unit further comprises a vehicle speed detector and a battery capacity detector, thereby when the oil supplying pump is driven by the pumping motor and an assistance control is performed by the main control unit, a power assistance for a steering wheel is started or stopped according to both a speed value from the vehicle speed detector and a battery capacity value from the battery capacity detector.

5. The driving assistance system of claim 4, wherein the power assistance for the steering wheel is started when the battery capacity value is above a first capacity threshold and the speed value is below a first speed threshold.

6. The driving assistance system of claim 4, wherein the power assistance for the steering wheel is started when the battery capacity value is between a first capacity threshold and a second capacity threshold and the speed value is below a second speed threshold.

7. A driving assistance system for power steering of a vehicle, wherein wheels of the vehicle are controlled to steer by a steering mechanism, an oil supplying pump supplies hydraulic oil to the steering mechanism, and the oil supplying pump is driven by the driving assistance system, the driving assistance system comprising:
a pumping motor for driving the oil supplying pump;
a main control unit for controlling the pumping motor, being an electronic component capable of controlling signals to be sent and received;
a battery for providing electric power to the pumping motor; and
a driving device, receiving signals from the main control unit and electric power from the battery to drive the pumping motor;
wherein the main control unit sends a command to the driving device to have the pumping motor powered by the battery when an electric power of the vehicle is activated.

8. The driving assistance system of claim 7, wherein the main control unit further comprises a vehicle speed detector, thereby when the oil supplying pump is driven by the pumping motor and an assistance control is performed by the main control unit, a power assistance for a steering wheel is started or stopped according to a speed value from the vehicle speed detector.

9. The driving assistance system of claim 7, wherein the main control unit further comprises a battery capacity detector, thereby when the oil supplying pump is driven by the pumping motor and an assistance control is performed by the main control unit, a power assistance for a steering wheel is started or stopped according to a battery capacity value from the battery capacity detector.

10. The driving assistance system of claim 7, wherein the main control unit further comprises a vehicle speed detector and a battery capacity detector, thereby when the oil supplying pump is driven by the pumping motor and an assistance control is performed by the main control unit, a power assistance for a steering wheel is started or stopped according to both a speed value from the vehicle speed detector and a battery capacity value from the battery capacity detector.

11. The driving assistance system of claim 10, wherein the power assistance for the steering wheel is started when the battery capacity value is above a first capacity threshold and the speed value is below a first speed threshold.

12. The driving assistance system of claim 10, wherein the power assistance for the steering wheel is started when the battery capacity value is between a first capacity threshold and a second capacity threshold and the speed value is below a second speed threshold.
